(19) United States
(12) Patent Application Publication
(10) Pub. No.: US 2023/0406566 A1
(43) Pub. Date: Dec. 21, 2023

(54) PRODUCT DISPLAY TRAY AND METHOD

(71) Applicant: Kiss Nail Products, Inc., Port Washington, NY (US)

(72) Inventors: Jane Bang, Bayside, NY (US); Taehoon Kim, Huntington Station, NY (US); Jaewon Tak, Bayside, NY (US)

(21) Appl. No.: 18/250,947

(22) PCT Filed: Sep. 16, 2021
(86) PCT No.: PCT/US21/50729

§ 371 Date: Apr. 27, 2023

Related U.S. Application Data
(60) Provisional application No. 63/079,220, filed on Sep. 16, 2020.

(51) Int. Cl. B65D 5/52; B65D 5/42

(52) U.S. Cl. CPC B65D 5/52; B65D 5/4204

(57) ABSTRACT

A tray for the display of products is described. The tray comprises a base and product display members formed from interconnected panels formed from a continuous substrate. The tray is formed from recyclable material and requires no external components during assembly, while still providing an attractive product display. The tray may be placed in an external container.

### PRIORITY CLAIM

The instant application is a U.S. national phase application of PCT application No. PCT/US21/50729 filed on Sep. 16, 2021, which claims priority to U.S. provisional filing 63/079,220 filed on Sep. 16, 2020, the contents of both of which are hereby incorporated by reference.

### BACKGROUND OF THE INVENTION

### 1. Field of the Invention

The field of the invention is a display and storage container for artificial eyelashes. In one embodiment, the storage container comprises a display box made from a single sheet of material such as paper or cardboard.

### 2. Background of the Invention

Storage of beauty accessories is a problem for both retailers and end-users. For the retailer, the product should be displayed in an attractive display case that entices customers to buy the item, prevents theft, and clearly shows the purchased product to avoid mistaken purchases that would result in merchandise returns. The product display and storage container should be easy to open for the end-user, and the product should be readily retrievable from the container.

The problem is particularly pronounced for small items, such as artificial eyelashes.

A standard solution is to place the product in a hard plastic case. Such a display case can be manufactured to be transparent but is not easy to open. When the hard plastic shell is opened, sharp edges can be created, resulting in a risk of injury. Further, product containers made out of hard plastic are difficult to recycle.

A need exists in the art for a product display package that is easy to assemble, avoids unnecessary plastic components, and is easy to use. A need also exists for a method of manufacturing such a product display case and container.

### SUMMARY OF INVENTION

An object of the invention is to create a product container and display tray that overcomes drawbacks in the prior art. A feature of the invention is that the product display tray includes protrusions to display the product on a stable base. An advantage of the invention is that the contained product is raised from a display base and can readily be accessed by the end customer. An additional advantage of the invention is that the end-user can easily see the features of the product within the container as the product is prominently displayed within the container.

A further object of the invention is to provide a product tray that can be made with no assembly. A feature of the invention is that the product display tray is made from a single substrate. An advantage of the invention is that the display tray does not require any assembly during manufacturing.

Another object of the invention is to create a product display tray that minimizes the use of plastic. A feature of the invention is that, in one embodiment, the main components of the display tray comprise a reinforced paper or cardboard. An advantage of the invention is that after use, the materials can be reused or recycled.

Yet another object of the invention is to provide a system for the display of a product that can be shipped in a flattened shape. A feature of the invention is that the container is formed by folding a substrate in specific locations, and the substrate can be shipped in a flattened state before assembly. An advantage of the invention is that the product container can be shipped as a single flat sheet prior to assembly and that the assembly does not require any additional components.

Another object of the invention is to provide a product display tray that can accommodate a variety of products and a variable quantity of products. A feature of the invention is that the display tray includes an interior chamber that can store multiple parts other than those on display.

Another object of the invention is to provide a display tray for a product that displays items with an adhesive element. A feature of the invention is that one surface of the display tray includes treatment for components with an adhesive layer, such as eyelashes. An advantage of the invention is that it can be used to dispense elements with an adhesive layer.

The invention provides an artificial eyelash display tray having a base and product display components formed by folding a single substrate of reinforced paper.

Also provided is a method for manufacturing a display tray, including cutting a substrate to the required shape, applying several creases, and cutting several slits.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1A depicts a perspective view of an assembled display tray, according to one embodiment of the system;

FIG. 1B depicts a perspective view of an assembled display tray, with artificial eyelashes added, according to one embodiment;

FIG. 1C depicts a perspective view of an external display box used with an embodiment of the display tray;

FIG. 1D depicts a perspective view of an alternative external display box used with an embodiment of the display tray;

FIG. 1E depicts a detailed view of the curved members of one embodiment of the invention;

FIG. 2A depicts an overview of a disassembled display tray, according to one embodiment;

FIG. 2B depicts an overview of a disassembled display tray, according to another embodiment;

FIG. 2C depicts an overview of another embodiment of the display tray;

FIG. 2D depicts an overview of another configuration an embodiment of the display tray;

FIGS. 3A-D depict an overview of the assembly of one embodiment of the tray; and

FIG. 4 depicts a flow chart of the manufacturing of one embodiment of the tray.

### DETAILED DESCRIPTION OF THE INVENTION

The foregoing summary, as well as the following detailed description of specific embodiments of the present invention, will be better understood when read in conjunction with the appended drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

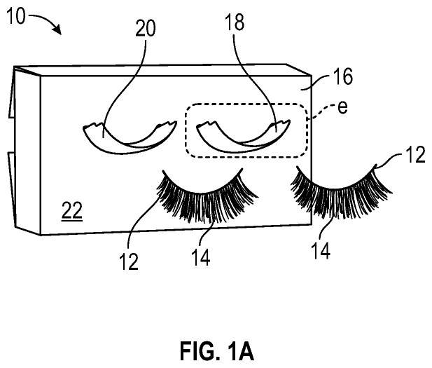

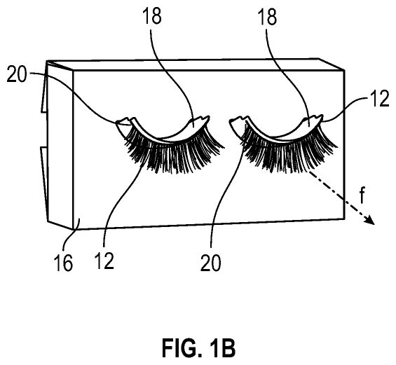

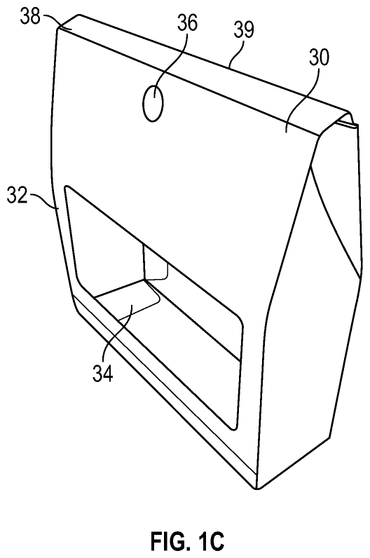

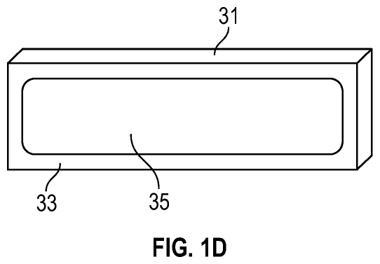

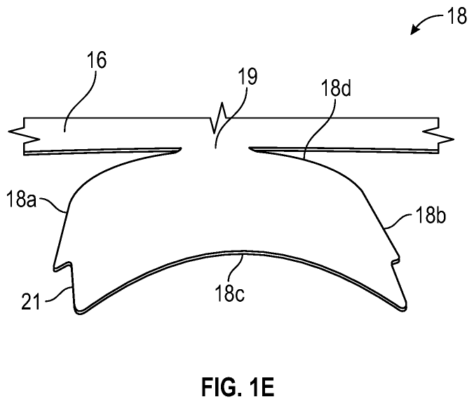

Turning to the figures, FIG. 1A, depicted therein is a display tray embodiment 10, showing one embodiment of the product display device or display tray. The display tray embodiment 10 comprises the display tray 16. The display tray receives a product to be displayed, such as artificial eyelashes shown in FIG. 1A. The artificial eyelashes include a lash strip 12 with at least one side, including an adhesive, in one embodiment. Lash filaments 14 extend from the lash strip 12. The adhesive on the lash strip 12 is pre-applied, in one embodiment, such as the artificial eyelashes described in the applicant's co-pending patent application Ser. No. 17/409,705, entitled “Ready-to-Use Eyelash Extensions,” the contents of which are hereby incorporated by reference. In other embodiments, the adhesive is applied separately.

A display platform removably receives the product. In the depicted embodiment, the display platform comprises curved members 18. In one embodiment, the product side 20 of the members 18 includes a coating. The coating allows for the product to be retained by the product display side but does not bond to the product adhesive fully, making the product removable. The coating results in the product side 20 becoming a laminated product display side. For example, for the lash strip 12 shown in FIG. 1A, the product side 20 includes a coating to allow for later removal of the lash strips 12 from the product side 20. As discussed below, the curved members 18 comprise a paper substrate, in one embodiment with the slick coating on the product side 20.

The curved members 18 protrude above the plane formed by the tray base 22. The display tray 16 can be oriented such that the tray base 22 is substantially vertical (as shown in FIG. 1A) or substantially horizontal. The details of the curved member 18 shown as area e in FIG. 1A are shown in FIG. 1E, described below.

FIG. 1B depicts the lash strips 12 being removably attached to the product side 20 of the curved members 18. The artificial eyelashes are removed from the members 18 by applying a force, such as pulling on the lash strips in the general direction depicted by the arrow denoted as f. The configuration, as shown in FIG. 1B, in one embodiment, is the configuration encountered by the end customer when viewing the product in a store, except that the display tray 16 is inserted in a secondary package, one embodiment of which is shown in FIG. 1C and another embodiment is shown in FIG. 1D.

FIG. 1C shows one embodiment of an external container 30, the interior of which holds the display tray (not visible in FIG. 1C). The external container 30 comprises multiple panels, including a front panel 32 which includes a clear viewing window 34. In one embodiment, the clear viewing window comprises a plastic film. The front panel also includes areas for marking, such as areas to receive the product brand name, the lot and serial number, as well as instructional markings. An aperture adapted to receive a display rod 36 is also defined in the front panel 32. A similar aperture is defined in the back panel (not shown), and therefore, the external container 30 may hang from a display rod at the point of sale. The panels, such as the front panel 32 are defined in the cardboard comprising the box 30 by a series of box fold lines 38, 39. One fold line 38 terminates the front panel 32, while another fold line 39 defines the boundary of the adjacent top panel. In this way, in at least one embodiment, the tray comprises a single sheet of cardboard.

As can be appreciated from FIG. 1C, each panel of the container 30 need not be the same size. In fact, the container 30 features an irregular shape with a top panel that is much narrower than the corresponding base panel. In the embodiment shown, the top panel is approximately one-third the size of the base panel.

FIG. 1D shows an additional embodiment of a tray container, which comprises an external box 31. The box 31 can also hold the display tray (not visible in FIG. 1D). The external box 31 has six walls adapted to receive the display tray with the curved members protruding from the tray base. The external box, in one embodiment, comprises a paper material, except for a front panel 33, which includes a clear plastic window 35. In this embodiment, the product attached to the curved members can be readily seen by the end purchaser at the time of purchase. The external box 31 has a more rectangular shape, with the sizes of the panels corresponding to each other.

### Curved Member Detail

FIG. 1E shows a detailed view of the curved member 18, first shown in FIG. 1A. The curved member 18 is defined by four edges. A first edge 18a includes a notched area 21, as shown in FIG. 1E. The notched area 21 results in the first edge 18a narrowing the main body of the curved member 18 at one end of the curved member 18. An opposing second edge 18b is a mirror image of the first edge 18a, including a corresponding notch. The curved member 18 also has a display edge 18c which defines the part of the curved member 18 which is adapted to display the end-product, as seen in FIG. 1A. On an opposite side from the display edge 18c is the base edge 18d, which includes a portion of material that acts as the connection point 19 with the rest of the tray 16 (only a small part of the tray 16 is visible in FIG. 1E). In one embodiment, the connection point 19 includes a scored line in the cardboard which is adapted to allow the curve member 18 to bend away from the tray 16 when folded.

The shape of the curved member 18 is particularly advantageous, as will be appreciated from the remainder of the description. The presence of notch 21 on the shorter edge 18a allows for easy assembly of the tray while preventing the tray from unintentional disassembly.

### Tray Details

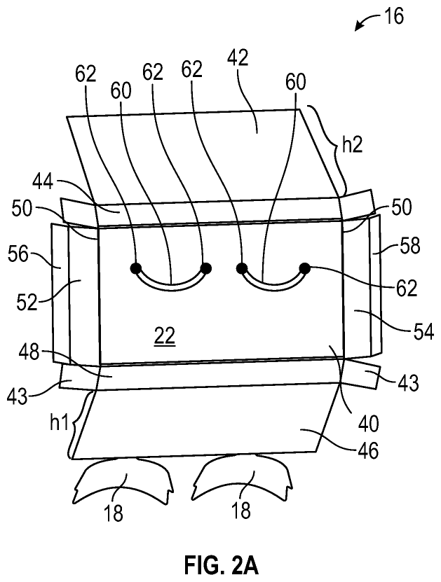

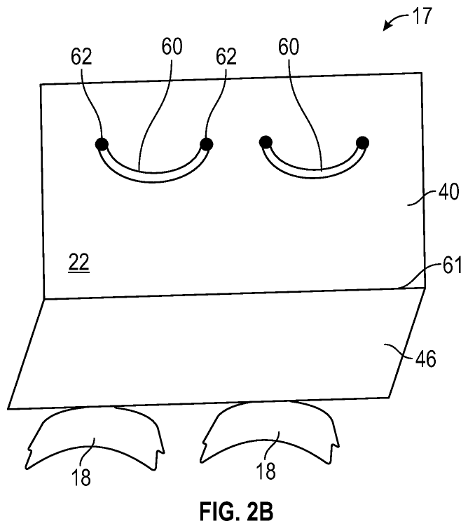

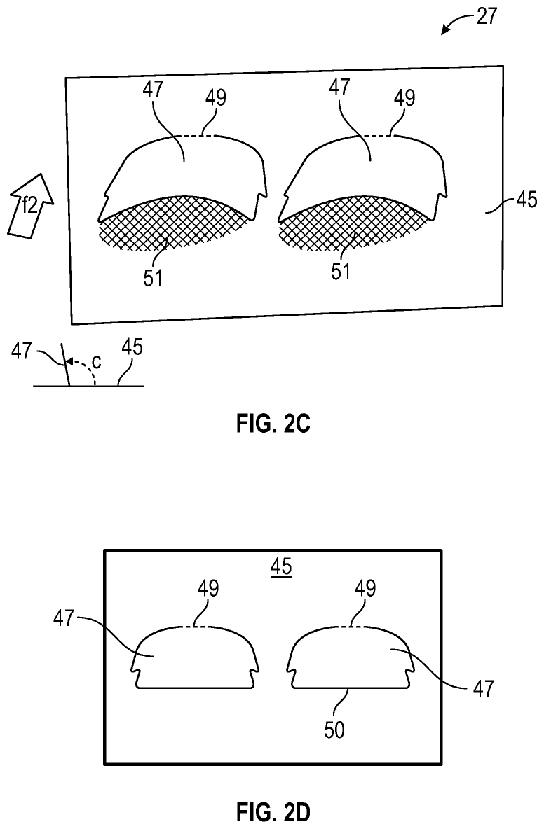

Turning to FIG. 2A, the figure shows a disassembled display tray 16 per the embodiment shown in FIGS. 1A and 1B in their assembled state. The display tray 16 includes a tray main body 40. The tray main body 40 comprises one continuous substrate, in the embodiment shown in FIG. 2A. In other embodiments, each sub-part described below is attached through appropriate means, such as glue, hook-and-loop fastener, stapling, riveting, and other attachment means.

The main body 40 comprises a substrate reinforced paper material in one embodiment. In other embodiments, the main body 40 comprises a cardboard material or a multi-layer paper product. As was discussed above, some parts of the main body 40 may have the added coating, such as the curved members 18. The main body 40 comprises a substrate based on plant-fibers, such as a cardboard substrate. In this way, the main body 40 is readily recyclable, or otherwise biodegradable.

In some embodiments, the product is sourced from a single material such as cardboard and can be recycled.

The main body is divided into panels in one embodiment. For embodiments where the main body 40 comprises a continuous substrate, the panels are defined using folds. In one embodiment, the folds are made by first scoring the substrate. The scoring process results in adding scored lines to the substrate.

In the embodiment shown in FIG. 2A, one of the panels is the tray base. Another panel, having approximately the same size, is the pedestal panel 42, and it is connected to the base 22 by a first side panel 44. The display panel 46 is also in communication with the tray base via the second side panel 48. In the embodiment shown in FIG. 2A, the panel 46 has a height h1, which is less than the height h2 of the pedestal panel 42. In other embodiments, the heights are substantially equal.

While multiple side panels are shown in the embodiment depicted in the figures, in some embodiments, the tray device comprises only one side panel.

The first side panel 44 and the second side panel 48 have different dimensions in the depicted embodiment, to form the assembled tray shown in FIG. 1A that has an angled display surface. The first side panel 44 and the second side panel 48 include folding wings 43, which are adapted to assist in the assembly of the paper tray 16.

As shown in FIG. 2A, the base has two narrower sides defined by narrow folds 50 that connect the base to the third side panel 52 and the fourth side panel 54. The third side panel 52 is then connected to a first flap 56, and the fourth side panel 54 is connected to a second flap 58. In some embodiments, each flap includes one surface that contains an adhesive layer so that when assembled, the flaps will remain in place. In other embodiments, the first flap 56 and the second flap 58 do not include any adhesive. In one embodiment, the side panels 52, 54 have different shapes, and the corresponding flaps are smaller than the depicted flaps 56, 58.

The third side panel 52 and the fourth side panel 54 are substantially the same sizes in the depicted embodiment. Further, the width of the third side panel 52 and the height of the first side panel 44 are substantially the same sizes in the depicted embodiment. Therefore, when assembled, as shown in FIG. 1A, or FIG. 1B, the panels form a substantially rectangular shape.

In FIG. 2A, the two curved members 18 are shown as attached to a longer edge of the display panel 46. However, in some embodiments, the curved members are attached to the longer edge of the pedestal panel 42. In yet other embodiments, one curved member 18 is attached to the display panel 46, while the other is attached to the pedestal panel 42.

The tray base 22 also includes several slits 60. The slits correspond in size to the thickness of the curved members 18. In this embodiment, a requirement, therefore, is that the height h1 of the display panel 46 allows the curved members 18 to reach the slits 60 when the display panel is bent back in the assembled configuration described below. In the embodiment shown, the several slits 60 comprise two slits. In other embodiments, only one silt is used. In yet other embodiments, more than two slits are formed. In the depicted embodiment, each slit includes at least one aperture 62 at each end of the slit to assist in the assembly of the display tray 16. In some embodiments, the apertures 62 are substantially circular and have a diameter that is ten to twenty percent larger than the width of each slit 60. The slit 60 comprises a cut, in one embodiment, a perforated line in another embodiment, or a combination of both. The slits length and width correspond to the product display member's outside contour such that the product display member may pass through the slit.

While the panels depicted in FIG. 2A are substantially rectangular, the panels may take on any number of shapes in other embodiments, which will result in a different shape for the assembled display tray. In some embodiments, at least several of the panels are substantially square. In other embodiments, at least some of the panels comprise a parallelogram, a trapezoid, a rhombus, or even an irregular polygonal shape, and combinations thereof.

### Alternative Trays

An alternative embodiment of the tray 17 is shown in FIG. 2B. In the alternative embodiment, the tray base 22 comprises two panels and the display members. The tray main body panel 40 includes one or more slits 60. Two distinct slits 60 are shown in the embodiment shown in FIG. 2B, but in other embodiment, the shape represented by the slits 60 is created by one continuous large opening.

The tray base 22 comprises the same materials in the embodiment 17 of FIG. 2B as in the embodiment 16 of FIG. 2A.

At least some of the slits 60 include the slit apertures 62, as shown in FIG. 2B.

The boundary between the display panel 46 and the main body panel 40 comprises a fold line 61, in the embodiment of FIG. 2B. In some embodiments, the fold line 61 is scored, in other embodiments it is formed simply as a fold line in the substrate.

Further, while the embodiment shown in FIG. 2B is adapted to display a pair of eyelashes, in other embodiments, the tray includes multiple curved members 18 and slits 60. For example, in one embodiment, the tray is used to display a set of five artificial nails and so five curved members 18 and five slits 60 are defined in the tray base 22.

In some embodiments, the display panel 46 is fixed in place by the addition of tape (not shown).

An alternative embodiment of the tray 27 is shown in FIGS. 2C and 2D. Depicted in FIGS. 2C and 2D is a tray base 45 and two product display members 47. The product display members 47 are folded out from the tray base 45 such that the product display members 47 protrude from the base 45. The product display members 47, and the tray base comprise a single substrate. In one embodiment, the product display members 47 are separated from the base 45 except for the fold lines 49. In some embodiments, the separation occurs with cutting 50; in other embodiments, the cuts are replaced by perforations 50. The cut or perforated lines 50 define the product display members' contour. Once the product display members 47 are defined in the base 45, force f2 is applied, folding them back along the fold line 49 so as to stand at an angle c with respect to the base 45. As can be appreciated from FIG. 2C, the angle c is more than 90 degrees in the depicted embodiment. However, the angle c can be any angle at which the display members remain upright, including 90 degrees, less than 90 degrees, and more than 90 degrees. In some embodiments, the fold lines 49 are curved, while in other embodiments they are straight. Also, in some embodiments, the fold lines 49 are not cut or perforated along their entire lengths, while in other embodiments some portion of each edge of the fold lines 49 may be cut so that the product display member 47 may be curved more easily. The curvature of the display member 47 is particularly advantageous when the display member is used to showcase flexible products that are curved, such as flexible strips of artificial eyelashes.

Upon folding of the display members 47, openings 51 are created in the base 45. In some embodiments, an adhesive substrate is added to at least one of the openings 51 so that the tray embodiment 27 can be secured to an external box, such as ones described herein.

### Assembly Steps

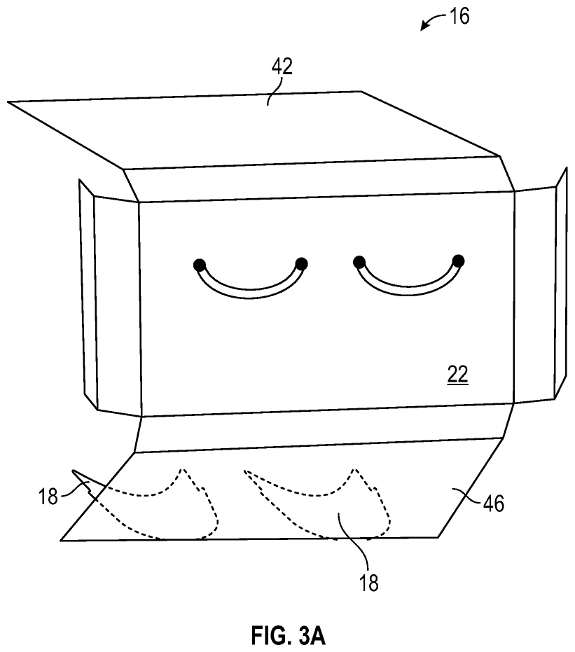

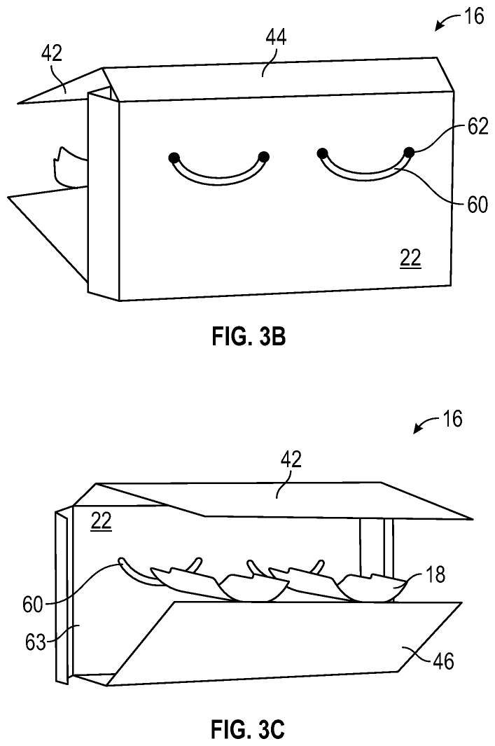

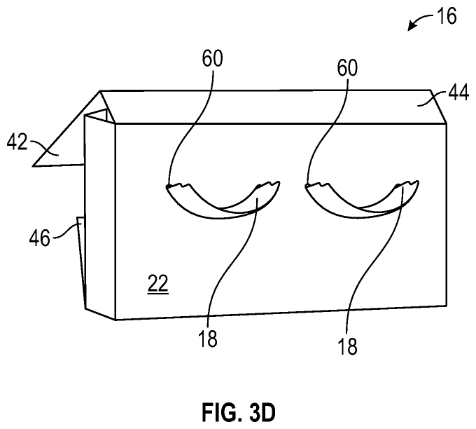

FIGS. 3A-D depict several stages of the assembly process. From the configuration of the display tray 16 shown in FIGS. 2A and 2B, in FIG. 3A, first, the curved members 18 are bent back to be substantially perpendicular to the display panel 46. The pedestal panel 42 is also bent back, away from the tray base 22.

As shown in FIG. 3B, the side panels are bent back in the next phase of the assembly process. The third side panel 52 is shown in its final position, forming a 90-degree angle with the plane of the tray base 22. The first side panel 44 is not yet in the final position so that the pedestal panel 42 does not obscure access to slits 60.

FIG. 3C depicts the tray 16 from the reverse side at approximately the same time, as shown in FIG. 3B. The curved members 18 are in substantial alignment with the slits 60 in the tray base 22. The pedestal panel 42 does not obscure the display panel 46 and allows the curved members 18 to pass through the slits 60.

As shown in FIG. 3C, a chamber 63 is formed from the intersection of the panels 42 and 46. This internal chamber can be used to store additional product pieces, a security device, an RFID tag, or other items not visible unless the tray is opened.

FIG. 3D depicts the state of the tray 16 once the curved members 18 have traversed the slits 60. Only the first side panel 44 needs to be bent to its final position, and the pedestal panel 42 needs to be configured to be substantially parallel with the tray base 22. The remaining side panels are substantially in their respective final configurations.

In one embodiment, the pedestal panel 42 includes an adhesive strip to attach it to the display panel 46. In another embodiment, no adhesive is used, but instead, the resilience of the material comprising the tray 16 is sufficient to maintain the configuration of each panel.

Following the folding of all the panels, the tray 16 reaches the assembled configuration shown in FIGS. 1A and 1B. In some embodiments that start from a single flat substrate, once assembled, the substrate becomes a folded substrate.

The various panels can be made with considerable tolerances in variation in size due to the use of a cardboard or paper material, which is resilient but also pliable. The folds which form the various panels can be adjusted in thickness to accommodate variances in the sizes of the panels. Further, the slits are made more extensive than necessary to accommodate the curved members to make the assembly process more comfortable.

In most embodiments, the various panels are kept in place using frictional engagement with little to no adhesive. The limited use of adhesive ensures that the display tray can be made simply by cutting the desired shape in a substrate (such as cardboard) and applying adhesive strips in only a few locations. In some embodiments, no adhesive strips are added.

A benefit of the embodiment shown above is that the packaging can include tamper-evident features, such as seals, on the external box 30 shown in FIG. 1C. The tray itself can be made from a homogenous material and require no added elements.

### Manufacturing Overview

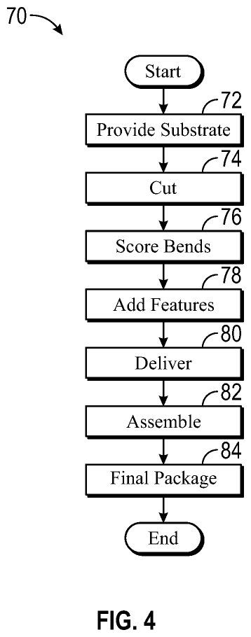

An overview of the manufacturing process 70 is shown in the flowchart in FIG. 4. The process begins with providing a substrate 72, such as a sufficiently large sheet of cardboard. In other embodiments, the provision of substrate 72 involves providing multiple segments of a substrate. In some embodiments of the process, the substrate is provided as a sheet. In other embodiments of the process, the substrate is sufficiently pliable so that it is provided from a roll.

Next, the general shape of the tray is cut 74 into the substrate. For example, in the embodiment shown in FIG. 2A or the embodiment of FIG. 2B, the cut of the substrate will create the external outline of the folded-out display tray.

After the general shape is cut into the substrate, the various bends lines are scored 76 into the substrate to provide boundaries for the various panels discussed above and to allow the panels to be bent back during the subsequent manufacturing and assembly steps.

Next, the various features of the tray are added 78. For example, the slits discussed above are cut into the middle of the base panel. Secondly, additional cuts are made around the curved members to facilitate the curvature. Any adhesive is also added to a limited number of locations in one embodiment of the system.

Following the addition step 78, the tray is substantially in the configuration shown in FIG. 2A or 2B, as discussed above. Optionally, the substantially flat trays are then delivered 80 to an assembly location. As the trays are substantially flat, delivery can be space and cost-efficient.

Once the trays arrive at the desired location, the trays are assembled 82, as was discussed in conjunction with FIGS. 3A-D discussed above. The various panels are bent back, and the curved members traverse the slits to form the assembled configuration shown in FIGS. 1A and 1B. The product that will be sold using the trays is added to the tray by attaching the product to the curved members.

Finally, the assembled trays are placed 84 in a final package, such as the box shown in FIG. 1C. The manufacturing process then ends.

It can be appreciated that the various steps use standard tools and techniques known in the manufacturing and cutting fields. The steps outlined above can readily be automated using a computer-controlled cutting device with interchangeable cutting tools. In some embodiments, the substrate includes a marker to help an automated system locate a corner of the shape to be cut during the cutting steps.

While the flowchart depicted in FIG. 4 shows the steps in sequential order, many of the steps can be accomplished in different orders, and some steps can be combined. For example, the cutting step and the step of adding features, such as cutting the slits, can be combined in some embodiments.

Although exemplary implementations of the invention have been depicted and described in detail herein, it will be apparent to those skilled in the relevant art that various modifications, additions, substitutions, and the like can be made without departing from the spirit of the invention. These are therefore considered to be within the scope of the invention as defined in the following claims.

It is to be understood that the above description is intended to be illustrative and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

1. A product display device comprising:
a base;
a product display member protruding from the base;
wherein said base and said product display member comprise a substrate.

2. The product display device of claim 1 wherein said base further comprises a slit.

3. The product display device of claim 2, wherein the product display member protrudes from the base through the slit.

4. The product display device of claim 2, wherein the base comprises a folding line and the slit comprises a cut or perforated line that defines the product display member's contour, and wherein the product display member is created by pushing the base along the cut or perforated line and folding along the folding line.

5. The product display device of claim 1 further comprising at least one additional side panel.

6. The product display device of claim 5 wherein said at least one additional side panel comprises four side panels.

7. The product display device of claim 5 wherein said at least one additional side panel is defined by scored lines and bends.

8. The product display device of claim 1 wherein said substrate comprises a single sheet of cardboard.

9. The product display device of claim 1 wherein said substrate comprises a multi-layered paper product.

10. The product display device of claim 1 wherein said product display member includes a laminated product display side.

11. The product display device of claim 1 wherein said product display member is curved.

12. The product display device of claim 1 further comprising an external box which removably receives the substrate.

13. The product display device of claim 1 wherein said product display device comprises a recyclable material.

14. A method of displaying a product comprising:
providing a substrate;
cutting said substrate to form at least one rectangular shape;
forming a base from said substrate;
defining display members in said substrate;
extending product display members from a plane formed by the base; and
adding the product to said product display members.

15. The method of claim 14 further comprising:
adding at least one slit to said base;
wherein extending the display members is performed by crossing through said at least one slit.

16. The method of claim 15 wherein the base includes two slits to receive the product display members.

17. The method of claim 14 further comprising:
delineating by folding at least one side panel in said substrate.

18. The method of claim 14 further comprises subdividing said substrate into four side panels.

19. The method of claim 18 wherein each panel is formed by scored lines and bends.

20. The method of claim 14 wherein said substrate comprises a single sheet of cardboard.

21. The method of claim 14 wherein said single substrate comprises a multi-layer paper product.

22. The method of claim 14 wherein said product display members include a laminated product display side.

23. The method of claim 14 further comprising curving said product display members.

24. The method of claim 14 further comprising adding an external box which removably receives the substrate.

25. The method of claim 14 wherein providing the substrate comprises providing a recyclable material.
